(19) United States
(12) Patent Application Publication
(10) Pub. No.: US 2026/0129629 A1
(43) Pub. Date: May 7, 2026

(54) DYNAMIC BANDWIDTH EXPANSION ACTIVATION AND TERMINATION OPERATION

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US)

(21) Appl. No.: 19/427,116

(22) Filed: Dec. 19, 2025

Related U.S. Application Data
(63) Continuation of application No. 19/205,972, filed on May 12, 2025.
(60) Provisional application No. 63/645,639, filed on May 10, 2024.
(60) Provisional application No. 63/766,935, filed on Mar. 4, 2025.

(51) Int. Cl. H04W 72/0457; H04W 72/0453

(52) U.S. Cl. CPC H04W 72/0457; H04W 72/0453

(57) ABSTRACT

Signal mechanisms are described for performing dynamic bandwidth expansion (DBE) at an access point (AP). In one embodiment, the AP and stations (STAs) exchange signals indicating their respective DBE capabilities (e.g., whether DBE is supported, maximum dynamic BW, etc.). Later, the AP (or a network controller) can determine to perform DBE. For example, the load on the AP may jump because the AP is located in a conference room or an event center. To provide additional BW, the AP (or RRM) can determine to perform DBE to increase the bandwidth available to the AP. To do so, the AP transmits a DBE announcement to inform the STAs. This announcement can include information such as bandwidth, center frequency, whether a subchannel is punctured, etc.). The AP and STAs can then use the expanded bandwidth.

### CROSS-REFERENCE TO RELATED APPLICATIONS

This application is a continuation of co-pending U.S. patent application Ser. No. 19/205,972 filed May 12, 2025, which claims benefit of co-pending U.S. provisional patent application Ser. No. 63/766,935 filed Mar. 4, 2025 and U.S. provisional patent application Ser. No. 63/645,639 filed May 10, 2024. The aforementioned related patent applications are herein incorporated by reference in their entirety.

### TECHNICAL FIELD

Embodiments presented in this disclosure generally relate to real-time dynamic bandwidth (BW) expansion (RT-DBE) or simply DBE.

### BACKGROUND

In enterprise deployments, wider channel bandwidths (e.g. 80, 160 & 320 MHz) are unlikely to be deployed, because the RRM (Radio Resource Management) logic and policy for enterprise deployments prefer stability for the WLAN and hence employs frequency reuse where available spectrum bandwidth is split among neighboring APs for those APs to operate on non-overlapping channels (each with different primacy channel). RRM logic typically employs high frequency reuse (e.g., a 10+ frequency reuse pattern), leading to adoption of e.g. 20/40 MHz channel bandwidth for 5 GHz and 20/40/80 MHz for 6 GHz. High client density also discourages use of wide-channels because Enhanced Distributed Channel Access (EDCA) performance quickly degrades in HD (e.g. 100+ stations (STAs)). RRM also limits channel changes and bandwidth changes due to legacy compatibility issues observed in 2.4 and 5 GHz spectrum where some legacy STAs will roam away from the AP when a channel switch is announced or may not connect to an AP that supports channel changes/channel switch. Hence, to avoid these negative impacts of legacy devices, channel changes are typically done infrequently in enterprise WLAN networks—e.g., once every day during off-peak hours or once every 8-12 hours, to minimize legacy compatibility concerns. Load on an AP typically varies with some APs experiencing high load on a temporal basis, e.g., during a meeting the access point(s) (AP(s)) in the conference room experience higher load because more devices are connected versus APs outside in the cubicle areas where smaller number of devices are connected. Given the increased load is temporary, but channel and bandwidth assignment are for much longer time scales (e.g. for a day), current enterprise deployments miss on the opportunity to provide higher throughput to serve higher temporal load.

Channel Switch Announcement (CSA) or Extended CSA (E-CSA) in 802.11 standard can support changing the operating BW of a basic service set (BSS). However, as described above using existing CSA or E-CSA to obtain more frequency or perform dynamic bandwidth change for RT-DBE has undesirable impacts on legacy devices. For example, most legacy stations (STAs) respond to CSA/E-CSA by roaming away and then roaming back (causing double scan/roam hit). To perform RT BW expansion using CSA/E-CSA (e.g., every few seconds or minutes), the double roaming has a serious negative impact on the performance of the legacy STAs. In addition, some legacy STAs will not associate with an AP that supports CSA. Further, CSA/E-CSA BW changes is designed for use with radio resource management (RRM), which is primarily for non-real time (or longer time scale) changes to channel and BW selection, and is not expected to be used for fast/real-time/frequent BW changes (e.g., at each transmit opportunity (TXOP) level, every millisecond, every second, or every minute or every few minutes etc.). In addition, the CSA/ECSA is mainly used for changing primary channel, which is not the case for DBE (or RT-DBE), where primary 20 MHz channel remains same and only BW changes. Using CSA/ECSA for only bandwidth change may cause field interop issues with legacy devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting, other equally effective embodiments are contemplated.

FIG. 1 is timing graph for performing DBE, according to one embodiment.

FIG. 2 is a flowchart for performing DBE, according to one embodiment.

FIG. 3 is a scheme for signaling DBE capabilities between an AP and a STA, according to one embodiment.

FIG. 4 is a scheme for announcing a DBE, according to one embodiment.

FIGS. 5A and 5B are schemes for signaling DBE BW parameters, according to one embodiment.

FIG. 6 is a scheme for signaling DBE BW parameters, according to one embodiment.

FIG. 7 is a flowchart for adjusting the BW of a neighboring AP in response to a DBE, according to one embodiment.

FIG. 8 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes managing, by an access point, a basic service set (BSS) on a first operating channel and at a first channel bandwidth; determining a mode switch time for a Dynamic Bandwidth Expansion (DBE) mode of operation for the BSS; prior to the mode switch time, transmitting by the access point, a wireless management frame that announces a switch to the DBE mode of operation for the BSS where the management frame includes data indicating the mode switch time and one or more DBE parameters; at the mode switch time, expanding, by the access point, a channel bandwidth of the BSS to a second channel bandwidth greater than the first channel bandwidth; and implementing, by the access point, the BSS in the DBE mode of operation at up to the second channel bandwidth for all DBE supporting stations.

One embodiment presented in this disclosure is an access point that includes one or more memories and one or more processors communicatively coupled to the one or more memories, where the one or more processors are configured to, individually or collectively, perform operations. The operations include managing, by the access point, a basic service set (BSS) on a first operating channel and at a first channel bandwidth; accessing a determination of a mode switch time for a DBE mode of operation for the BSS, prior to the mode switch time, transmitting by the access point, a wireless management frame that announces a switch to the DBE mode of operation for the BSS, the management frame including data indicating the mode switch time and one or more DBE parameters; at the mode switch time, expanding, by the access point, a channel bandwidth of the BSS to a second channel bandwidth greater than the first channel bandwidth; and implementing, by the access point, the BSS in the DBE mode of operation at up to the second channel bandwidth for all DBE supporting stations.

One embodiment presented in this disclosure is a non-transitory computer readable storage medium including instructions that when executed configure one or more processors of an AP to perform operations. The operations include managing, by the AP, a BSS on a first operating channel and at a first channel bandwidth; accessing a determination of a mode switch time for a DBE mode of operation for the BSS; prior to the mode switch time, transmitting by the access point, a wireless management frame that announces a switch to the DBE mode of operation for the BSS, the management frame including data indicating the mode switch time and one or more DBE parameters; at the mode switch time, expanding, by the access point, a channel bandwidth of the BSS to a second channel bandwidth greater than the first channel bandwidth; and implementing, by the access point, the BSS in the DBE mode of operation at up to the second channel bandwidth for all DBE supporting stations.

### Example Embodiments

CSA or E-CSA changes the BW for all the STAs in the BSS. However, not all STAs may support RT-DBE capability, hence using CSA/E-CSA limits when RT-DBE can be used since CSA/ECSA is not understood by all legacy devices. Further, STAs can support different maximum dynamic BWs (e.g., some STAs can support expanded BW operation up to 160 MHz bandwidth while other STAs can support expanded BW operation up to 320 MHz bandwidth), but CSA/ECSA applies across all STAs, hence it cannot differentiate STAs based on their support for dynamic BW capability. In a deployment where STAs have different maximum dynamic BWs, the dynamic BW is limited to the minimum value of the maximum dynamic BW of the STAs (e.g., 160 MHz in this example) if CSA/ECSA is used. For these reasons, CSA/E-CSA cannot provide RT-DBE. Similarly, other schemes or BW changing messaging protocols such as changing BSS operating BW in a BSS operation element or using operating mode notification (OMN) cannot provide RT-DBE functionality due to legacy STAs not being tested for frequent BW changes using those schemes. Also, STAs in power save may not receive Beacons and/or OMN and can miss BW changes.

In enterprise deployments, the RRM logic can be enhanced to account for temporal load variations and CCI (co-channel interference) variations across neighboring APs. APs that have higher loads than other neighboring APs can perform DBE—e.g., expand bandwidth from 40 MHz to 160 MHz for some time duration (e.g. 5/10/20/30/60 minutes) to serve the higher load. The DBE mechanisms proposed here enables opportunistic use of wider bandwidth in enterprise and other deployments (e.g., to serve higher load or better serve higher quality of service (QoS) traffic), enabling enterprise networks to achieve higher throughput and better QoS performance to meet throughput and satisfy the desired QoS/service level agreement (SLA).

Embodiments herein describe signaling mechanisms for performing RT-DBE (or DBE) at an access point (AP) and serving one or more STAs that support DBE over the expanded BW of DBE. In one embodiment, the AP and STAs (e.g., user devices) exchange signals indicating their respective DBE capabilities (e.g., whether DBE is supported, maximum DBE dynamic BW supported, list of one or more dynamic BW supported etc.). Later, the AP (or a network controller) can determine to perform DBE. For example, the load on the AP may jump because the AP is located in a conference room or an event center. To provide additional BW to serve higher load, the AP (or the RRM logic or controller) can determine to perform a DBE operation which makes the wider channel BWs, e.g., 80 MHz, 160 MHz or 320 MHz, available to the AP. To do so, the AP transmits a DBE announcement in advance to inform the STAs about an upcoming expanded BW. This announcement can include information of the expanded DBE bandwidth such as expanded DBE channel bandwidth, center frequency for the expanded BW, whether one or more subchannel is punctured within the expanded BW, etc.) and indicate the start time (or the DBE BW switch time) when the BW will be expanded. The DBE BW switch time can be indicated, e.g., as the number of target beacon transmission time (TBTTs) till the AP switches to the DBE BW or a future timing synchronization function (TSF) time when the DBE BW switch happens. The DBE announcement can be sent for certain beacon intervals in advance (before DBE BW change takes place) e.g., sent for few DTIM beacon intervals or can be sent for larger number of beacon intervals based on the listen interval of associated STAs that support DBE. This enables STAs to prepare and get ready to operate at the expanded BW. In one embodiment, signaling for the advance DBE announcement can be provided as part of one or more of beacon, probe response, fast initial link setup (FILS) discovery or (re)association response frames.

Once the BW is expanded, the AP is operating with an active DBE mode or active DBE session. The AP also indicates to the STA that it is operating with DBE expanded BW (active DBE session or mode) and indicates expanded DBE bandwidth parameters to the STAs. As above, the DBE bandwidth parameters provided after BW expansion can include expanded DBE bandwidth, channel center frequency for the expanded BW, whether one or more subchannel is punctured within the expanded BW etc. DBE bandwidth parameters provided after BW expansion can be indicated in beacon, probe response, FILS discovery or (re)association response frames. This signaling from the AP can be used to notify STAs that may have been sleeping that a DBE session or mode is currently active in the BSS.

In some embodiments, current DBE BW remains active until the AP sends another DBE announcement to change the DBE BW or terminate the DBE mode (or session). The subsequent DBE announcement to make changes or terminate DBE mode is also announced for some time duration in advance, e.g., a certain number of beacon intervals. In some embodiments, the AP may change DBE bandwidth of a currently active DBE session to another DBE bandwidth, e.g., change DBE BW from 160 MHz to 320 MHz. The AP can achieve this by sending another DBE announcement indicating DBE bandwidth parameters for the changed DBE BW. In some embodiments, the DBE mode (or session) remains active until the AP sends another DBE announcement indicating the termination of the DBE mode. For example, the AP may wait until its load decreases to terminate the active DBE mode/session. However, in another example, the original DBE announcement can include a duration indicating a start and stop time of the DBE session. After the DBE session is terminated, the AP and DBE supporting STAs return to operating at the BSS operating BW.

Advantageously, the signaling mechanisms discussed herein do not have a negative impact on legacy STAs because those STAs would not support the new DBE signaling schemes described herein. In this manner, DBE operation can be performed in RT to achieve dynamic and more frequent changes to AP's bandwidth for DBE supporting STAs, to accommodate and serve increased loads on an AP without having a negative impact on legacy STAs (e.g., the legacy STAs ignore the signaling discussed herein and can function as normal).

Note that RT-DBE and DBE terms are used interchangeably in this document.

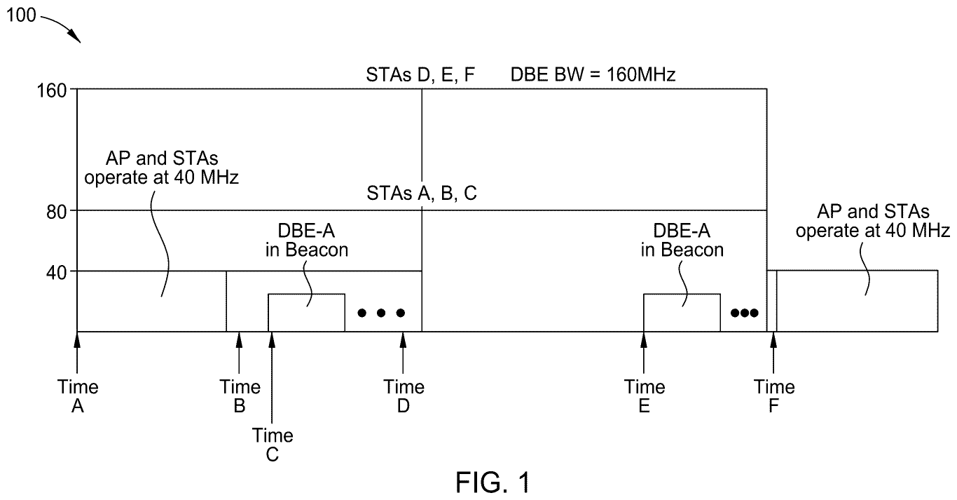

FIG. 1 is timing graph 100 for performing DBE, according to one embodiment. The y-axis of the graph 100 indicates the bandwidth of a BSS provided by an AP while the x-axis indicates time. The bandwidth of the BSS is expressed as a channel width (e.g., 40 MHz, 80 MHz, 160 MHz, 320 MHz, etc.). When deployed in an enterprise at Time A, RRM logic or some other resource management scheme can be used to assign a BSS BW to the AP. In this example, 40 MHz is the default operating bandwidth of the BSS which is used by the AP and STAs in the BSS.

At Time B, RRM determines to expand the BW of the AP to be used for STAs that can support expanded DBE BW operation. For example, RRM may identify an increased load at the AP (e.g., more STAs have associated with the AP or the STAs have increased BW needs) or determine to expand the BW based on reduced co-channel interference (CCI) from neighboring APs or a combination of the two, and may consider other conditions. While expanding the BW can cause neighboring APs in the deployment to potentially have overlapping subchannels which can reduce WLAN stability, the DBE BW expansion can be temporary in order to respond to increased loads (which also may be temporary).

At Time C, the AP sends out DBE announcements to inform the STAs of an upcoming expanded BW DBE operation. As discussed in more detail below, the announcement informs the STAs the expanded DBE BW is being increased (e.g., being expanded from 40 MHz to 160 MHz bandwidth), channel center frequency for the DBE BW, any punctured subchannel within the DBE BW, a DBE BW switch time/start time, duration for how long DBE expanded BW operation will last (which is optional), etc. This advance DBE announcement provides time for the STAs to re-calibrate their hardware for operating at the new bandwidth.

At Time D, the DBE BW expansion occurs. As illustrated in FIG. 1, the BW of the AP increases to 160 MHz (from 40 MHz) in this case. In some embodiments, different STAs may support different capability for maximum DBE BW that is supported by the STA. FIG. 1 illustrates that some STAs may utilize less than the maximum DBE dynamic BW, e.g., because they support smaller maximum DBE BW capability. For example, the STAs A, B, and C may only be capable of using 80 MHz channel bandwidth. Nonetheless, FIG. 1 illustrates the embodiments herein permit STAs to access the increased/expanded BW, even if they cannot utilize subchannels on the entire expanded BW. In contrast, the STAs D, E, and F can utilize the entire DBE bandwidth during the expanded BW operation.

At Time E the AP transmits a DBE announcement indicating the DBE mode/session is going to terminated or end at Time F. As such, the AP can continue to use the expanded BW until Time F. The announcement sent at Time E (e.g., a termination or reset announcement) can be similar to the announcement sent at Time C except it indicates when the active DBE mode/session will terminate by indicating a DBE BW switch time when DBE mode will terminate. This DBE announcement can indicate the termination of the DBE mode using an explicit ‘DBE termination’ field or it could indicate DBE termination by setting DBE bandwidth parameters to indicate BSS bandwidth parameters (in this case 40 MHz, which signals to STAs that DBE BW is being reset to the BSS BW). In either case, this DBE announcement gives the STA enough time to prepare (e.g. recalibrate their hardware) to return to the default operating BW of the BSS at the DBW BW switch time indicated.

However, in another embodiment, the AP may indicate the duration, or end time, of the DBE mode in the DBE announcement that was sent at Time C. In that scenario, the DBE mode terminates at the end of the duration or at the end time indicated in that DBE announcement, without the AP sending another announcement.

At Time F, the AP ceases using the expanded BW and returns to the default BW of the BSS (e.g., 40 MHz). After Time F the AP and the STAs operate with default BSS BW.

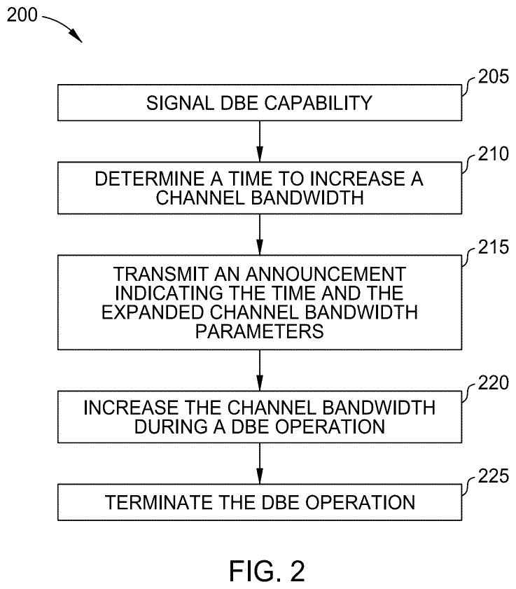

FIG. 2 is a flowchart of a method 200 for performing DBE operation, according to one embodiment. At block 205, the AP and the STA signal to each other their DPE capabilities—i.e., support for DBE, the Maximum (Max) DBE Bandwidth Supported. In one embodiment, the AP and/or STA also indicate the list of channel bandwidths for which DBE operation is supported. For example, the AP or STA can indicate that it supports DBE for 40, 80, 160 and 320 MHz bandwidths. In one embodiment, the AP and STA indicate support for DBE in an element, e.g., in an ultra-high reliability (UHR) element such as a UHR Capabilities element (e.g., in UHR MAC Capabilities field of that element) and/or in a UHR Operation element. This element can also indicate a maximum DBE BW that is supported for DBE BW expansion (e.g., if the AP/STA supports 80 MHz, 160 MHz, 320 MHz DBE BWs, etc.). In one embodiment, the AP and STA in addition (or in place of maximum DBE BW) can indicate the specific set of expanded BWs they support for DBE, e.g., signal support for operating at 40, 80, 160 and 320 MHz (e.g. using a bitmap or another field) DBE BWs. The STA can later update its ‘Max DBE Bandwidth Supported’ when enabling participation in the DBE feature. In one embodiment, the AP can also signal its maximum DBE Bandwidth switch time that indicates the maximum time taken by the AP to expand its channel bandwidth, as part of its DBE related capabilities or capability parameters provided to the STAs (e.g. in the UHR Capabilities element or another element carrying AP's DBE capability parameters).

In one embodiment, the AP announces its DBE related capabilities in Beacon, Probe Response, FILS Discovery frames, Association Response, Reassociation Response and/or another management frame. The STA can announce its BDE capabilities in an Association Request, Reassociation Request and/or another management frame.

In another embodiment, the AP and STA can signal their DBE related capabilities in action frames used for dynamic BW selection negotiation.

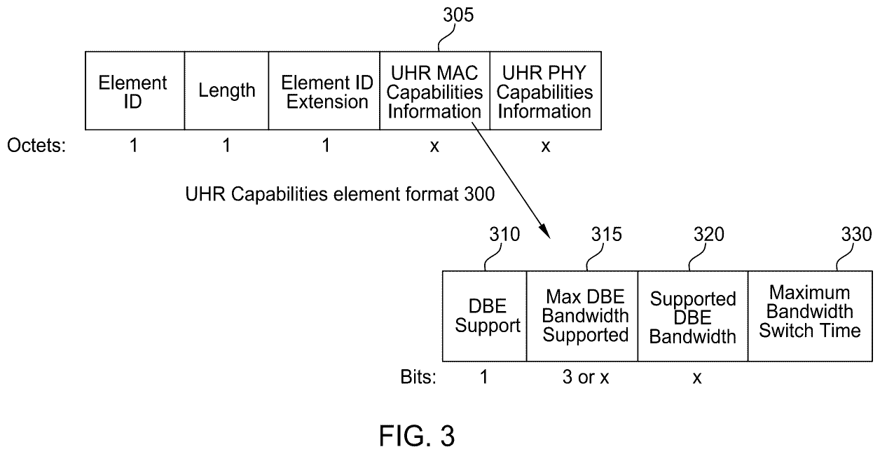

FIG. 3 is a scheme for signaling DBE capabilities between an AP and a STA, according to one embodiment. That is, FIG. 3 illustrates signaling formats that an AP and STA can use to exchange DBE capability information as discussed at block 205 of method 200.

FIG. 3 illustrates a UHR capabilities element format 300 that includes a UHR MAC capabilities information field 305. A detail view of this field 305 is shown at the bottom of FIG. 3. It can include a DBE support flag 310 that indicates if the STA or AP supports DBE. For example, the flag 310 can be a bit that is set to a specific value (e.g., set to 1) to indicate that the STA or AP supports DBE. The field 305 also includes a Max DBE Bandwidth supported value 315 (e.g., this field can be set to 40 MHz, 80 MHz, 160 MHz, 320 MHz, etc.) that indicates the maximum DBE BW that is supported by the AP or STA. The field 305 also includes the supported DBE bandwidths field 320, which can list out the channel bandwidths that are supported explicitly or by using a bitmap. For example, a STA may support channel bandwidths of 40 MHz, 80 MHz, 320 MHz, but not 160 MHz. This can be indicated in the supported DBE bandwidths field 320. An AP may also indicate that it supports DBE bandwidths of 80, 160 and 320 MHz. Indicating explicit BWs may help STAs to better calibrate for these expanded BWs when the DBE mode becomes active. In one embodiment, optionally a maximum Bandwidth switch time 330 can also be indicated.

Returning to block 210 of method 200, the AP (or RRM with the AP's input) determines a first time to increase a channel bandwidth between the AP and one or more STAs that support DBE. That is, the AP determines a time to expand the BW of the AP for DBE supporting STAs (or DBE supporting STAs that have also enabled the DBE mode). As discussed above in FIG. 1, this decision can be based on an increased load at the AP, due to reduced CCI measurement from neighboring APs, or any other situation where an AP could benefit from DBE operation with expanded BW.

At block 215, the AP transmits a message (e.g., an announcement) indicating the time and the expanded channel bandwidth capability parameters for DBE BW. Put differently, the AP announces the DBE mode in advance. In one embodiment, AP determines the expanded BW used in the announcement based on the set of associated STAs which support DBE feature (as learned at block 205) and their Max DBE BW supported.

In one embodiment, the DBE announcement is made using a Dynamic Bandwidth Expansion Announcement (DBEA) element or another element, e.g., a new UHR element or another existing element. In one embodiment, the DBE announcement can be made using an element that advertises or announces critical updates in the BSS in advance and DBE announcement is considered a critical update. The DBE announcement indicates the expanded DBE Bandwidth, a channel center frequency corresponding to the DBE BW (which can be indicated by CCFS0 and CCFS1 fields defined in the IEEE 802.11 be draft), and a Disabled Subchannel Bitmap indicating list of punctured subchannels within the DBE BW. For example, some of the subchannels in the expanded channel may have incumbent users, and those subchannels are punctured so that the AP and STA cannot use those subchannels. These punctured subchannels are indicated by the disabled subchannel bitmap. However, if there are no punctured subchannels, this bitmap can be omitted. The presence of disabled subchannel bitmap can be indicated by a presence field, e.g., a disabled subchannel bitmap present bit.

In one embodiment, different sets of dynamic DBE BWs (e.g. 120 MHz or 140 MHz) can be signaled using a more common DBE BW, e.g., 160 MHz in this case and then use puncturing to indicate that other subchannels are not used to result in the desired bandwidth. That is, if 120 MHz expansion is desired, the AP can announce a 160 MHz BW expansion but then use the disabled subchannel bitmap to puncture one or more subchannels having 40 MHz of BW to result in the desired 120 MHz bandwidth.

The AP can announce the element carrying the announcement for DBE (e.g., a DBEA element or another UHR element) in Beacon, Probe Response, (Re)Association Response, FILS Discovery or another management frame for certain beacon intervals. Moreover, the DBEA element can be a separate element carrying DBE announcement, or DBE announcement can be made as part of other management element(s) such as an element used for announcing critical updates in the BSS.

The announcement can also indicate a time when the DBE starts or begins. To do so, in one embodiment the element providing the DBE announcement includes a switch time field that indicates the start time when the dynamic BW expansion will become effective. In one embodiment, the switch time field indicates a Bandwidth Switch Count that indicates the number of target beacon transmission times (TBTTs) until the AP switches to the DBE expanded BW. In one embodiment, the switch time field could indicate a TSF time for when the dynamic BW expansion starts, instead of number of beacon intervals. In one embodiment, the switch time field can indicate the TSF time for start of the DBE in granularity of TUs (e.g., time units which are equal to 1024 microseconds).

The advance announcement of DBE enables a STA to prepare for operating with expanded BW. For example, the STA can pre-calibrate its hardware to use for the expanded BW. The AP could also use time during the DBE announcement to better prepare for switching to the expanded BW. For example, the AP could also pre-calibrate its hardware for expanded BW operation.

In one example, the element providing the DBE announcement (e.g., a DBEA element or another UHR element) includes a Dynamic BW duration field that indicates the duration (e.g. in unit of TUs) for which dynamic BW expansion will be active. If no duration is indicated, then the current dynamic BW expansion remains active until explicitly changed or terminated by the AP transmitting another announcement as described below.

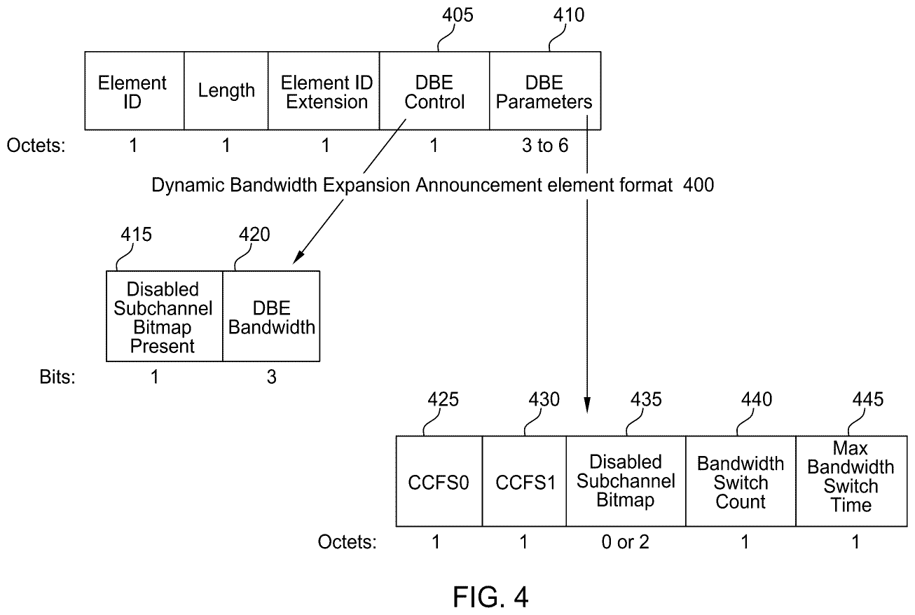

FIG. 4 is a scheme for announcing a DBE, according to one embodiment. That is, FIG. 4 illustrates a signaling format 400 of a DBEA element as discussed at block 215 of method 200. FIG. 4 is one format option for DBE announcement. Other format options for DBE announcement are possible where DBE capability parameters captured in FIG. 4 are carried in another UHR element, e.g., in an element defined for critical updates in the BSS. The format 400 includes a DBE control field 405 and a DBE parameters field 410. In another embodiment, fields in the DBE Control and DBE Parameters may be combined into a single top level field that carries subfields.

The DBE control field 405 can include the disabled subchannel bitmap present flag 415 indicating whether the disabled subchannel bitmap 435 is present in the DBE parameters field 410, and the DBE bandwidth 420.

The DBE parameters field 410 includes channel center frequency information in for DBE bandwidth in the CCFS0 field 425 and CCFS1 field 430, a disabled subchannel bitmap 435 indicating any punctured subchannels that cannot be used by the AP or STAs, a bandwidth switch count 440 (e.g., this indicates a number of TBTTs until the AP switches to the DBE BW or TSF time when the AP switches to DBE BW), and an optional max bandwidth switch time 445. The maximum bandwidth switch time 445 indicates the maximum time taken at the AP for switching to the DBE expanded BW. In one embodiment, switch time 445 can also indicate the time taken to reset AP's DBE BW to the BSS Operating BW (e.g., from 160 MHz expanded BW back to the 40 MHz BSS operating BW) when the DBE operation is terminated. Alternatively, a different ‘Max BW Switchback time’ field (optional field) can be announced if the time for the AP to reset back to the BSS operating BW is different from the time it takes for the AP to switch to the DBE expanded BW. These time values can be specified in granular units e.g. 64 microsec, 128 microsec, 256 microsec, 512 microsec, 1 TU, etc.

In one embodiment, the AP uses a separate Dynamic Bandwidth Expansion Announcement (DBEA) action frame to announce dynamic BW expansion to STAs instead of or in addition to using Beacon and Probe response frames. The DBEA action frame can includes the DBEA element or another element used for DBE announcement as proposed above. The DBEA action frame can also include an association identifier (AID) Bitmap when sent as broadcast intended for a group of STAs identified by the AIDs in the AID Bitmap. The DBEA action frame can be sent 1:1 to STAs or broadcast to all STAs or a group STAs (identified using the AID Bitmap).

Moreover, an AP may learn by exchanging the DBE capabilities at block 205 that associated STAs have different Max DBE BW capability (e.g. some STAs have 160 MHz and some have 320 MHz max DBE BW capability). In this scenario, in one embodiment, the AP may want to announce multiple active DBE sessions in Beacon or Probe Response frames. The AP can signal multiple sets of Dynamic BW Expansion within a given element used for DBE announcement as proposed above. For example, the DBEA element can indicate both dynamic BW expansion to 160 MHz and 320 MHz. One way the AP can signal this by using a Dynamic BW Bitmap which, for example, includes four bits one each for 40, 80, 160 and 320 MHz. A STA operates at the expanded dynamic BW based on its Max Dynamic BW capability and dynamic bandwidths announced in the DBEA element. This allows dynamic BW operation at maximum channel bandwidth supported across STAs, instead of limiting max BW to lowest of Max Dynamic BW across all supporting STAs.

When indicating multiple DBE BW expansions, the AP may assume that the supporting STAs can operate at their max dynamic BW supported during the time period when DBE is activated. However, each DBEA element may have different start-time and durations to allow the AP to operate at different max DBE BWs.

In another embodiment, the AP can announce only one DBE BW expansion that may be the highest maximum channel bandwidth that is supported by one or more associated STAs. For example, if some associated STAs (e.g., STAs A, B and C in FIG. 1) support max DBE BW of 160 MHz and other STAs (e.g., STAs D, E and F in FIG. 1) support max DBE BW of 320 MHz, then the AP can announce a DBE BW expansion of 320 MHz. In this case when DBE BW expansion becomes effective, the STAs would operate up to their maximum supported DBE BW, so STAs A, B and C operate up to max BW of 160 MHz and STAs D, E and F operate up to max BW of 320 MHz. In this scheme, AP does not need to support multiple concurrent DBE BW expansions.

In yet another embodiment, the AP performs an individual dynamic BW negotiation with each STA. As previously mentioned, the associated STAs may have different Max DBE BW capabilities. In such a case, the AP may want to negotiate DBE individually with STAs. To do so, the AP can use a DBE request action frame to indicate to a STA about the intent of the AP to change the BW in near future (at DBE Start Time). The DBE request frame can include the DBEA element (or another element such as a UHR element) to signal dynamic BW, Channel Center frequency, Disabled Subchannels, DBE Start time, and optionally a DBE Duration. The DBE responses from the STA could be collected individually from each STA (low-scale) when individual DBE session is established with a small number of STAs. In another embodiment, DBE request to establish DBE session can be sent to multiple STAs using downlink (DL) Orthogonal Frequency-Division Multiple Access (OFDMA). Then the DBE responses from multiple STAs can be received using multi-user (MU)-uplink (UL)-physical layer protocol data unit (PPDU) (high-scale). This scheme provides a more efficient way to setup individual DBE sessions with multiple STAs.

A STA may not always accept expanding to the dynamic BW indicated by the AP in a DBE Request. The STA may be able to expand only to a lower BW (e.g. due to power saving). The STA can indicate the dynamic BW it can support in a DBE Response. Based on multiple STAs selected dynamic BW in DBE Responses, an AP may support multiple sets of Dynamic BW during a given DBE activation duration, as discussed above. For example, the AP may use BW 120 MHz with STA1 and STA2, but may use BW 160 MHz with STA3 and STA4, based on the STAs responses. In one embodiment, the AP operates multiple DBE BWs in parallel (AP can time align its BW expansion across all STAs, even if it uses different dynamic BWs for different STAs) or it can operate the different DBE BWs over different time periods (which could be overlapping or non-overlapping) based on what would work best. For example, the AP may use multiple access point coordination (MAPC) to coordinate with other APs to determine the best schedule for switching between the different expanded BWs for its own BSS.

Returning to the method 200, at block 220 the AP increase the bandwidth at the announced time. That is, the AP expands its operating BW for STAs that support expanded channel bandwidth operation (and if explicit enablement of DBE operation is desired, then have also enabled DBE operation). At the time stipulated in the announcement for DBE, the AP expands the BW to activate the DBE mode.

Once the dynamic BW operation is active, STAs that support DBE feature (and/or have enabled it) operate with the dynamic BW for their Enhanced Distributed Channel Access (EDCA) operation. The AP also operates with expanded BW for these DBE supporting STAs. The BSS BW remains the same as indicated before so there is no impact to legacy STAs or STAs that do not support DBE operation. However, the AP uses DBE BW announced in its downlink (DL) single user (SU) and MU transmissions for a DBE supporting STA based on STA capability for the max dynamic BW. The AP can also use dynamic BW in its UL Trigger access for these STAs. Both the AP and STA can use maximum PPDU BW for DL and UL to be the minimum of the max DBE bandwidth of the STA or the AP's currently active DBE bandwidth.

When the AP individually negotiates for DBE with a STA (as discussed above), the AP can use the negotiated BW for DL SU and MU transmissions for the STA. The AP also uses the negotiated dynamic BW in its UL Trigger access for that STA.

Moreover, sub-band operation (e.g., dynamic subchannel operation (DSO) and non-primary channel access (NPCA)) can use the max expanded DBE BW for DBE supporting STAs that also support these other features.

While the DBE mode is activated, the AP can continue to signal the DBE BW parameters in an element in Beacon, Probe Response, (Re)Association Response etc., e.g., in a UHR operation element or in a UHR element carrying parameters for DBE and/or other operating modes (e.g., a UHR Operating Parameters element or an element used for UHR critical updates). For example, the UHR operation element (or another element) can indicate that the DBE mode is active (e.g., by setting a DBE Activated bit to 1), as well as provide information similar to what is in the announcement such as the increased DBE BW, CCFS0, CCFS1, Disabled Subchannel Bitmap (if any), etc. This can be used, for example, to alert STAs that were asleep when the DBE was announced that a DBE mode has been activated. In some embodiments, the UHR operation element may carry only the information that DBE mode is active and may not carry detailed DBE BW parameters to minimize beacon overhead or bloating. In another embodiment, the AP may carry DBE parameters only for some period in the beginning when the DBE mode becomes active (e.g., in a UHR element but likely not the UHR Operation element) to minimize overhead in beacon frames. In some embodiments, the AP may not carry DBE parameters in the beacon after DBE mode is activated again to minimize beacon bloating issue. For STAs that were not able to acquire DBE parameters from DBE announcement (made over multiple beacon intervals) or from advertisement of DBE parameters after DBE is activated, would have to acquire DBE parameters using 1:1 exchange with the AP, e.g., using Probe Request/Response exchange.

In one embodiment, if the AP supports the DBE feature, it signals that in the capabilities field, e.g., in the UHR MAC Capabilities field of UHR Capabilities element by setting the DBE Support value to indicate that the AP supports DBE (e.g. by setting DBE Support to 1). In one embodiment, the AP can also dynamically enable/disable the support for DBE feature. The AP may announce enable or disable of the DBE feature in advance using a similar announcement scheme as for activation of DBE mode with expanded BW operation. In this case an element such as an element used to indicate a critical update (e.g. a Critical Parameters Update element or another element name) would indicate that DBE feature is being enabled or disabled by the AP at some time in future and then AP would take the action to enable or disable the DBE feature at that time. In this case, an element such as the UHR Operation element can indicate whether the DBE feature is enabled in the BSS by the AP for example by setting a DBE Enabled field to 1 (e.g., this may be useful because UHR Capabilities element is not always carried in the beacon). Moreover, an AP may not be operating in an active DBE mode/session with expanded DBE BW always when the DBE feature is enabled. In this case, the DBE Activated field can be set to indicate whether the DBE mode is active or not. For example, if the DBE feature is enabled and the DBE mode/session is not active then the DBE enabled bit is set to 1 but DBE activated bit is set to 0. However, when DBE feature is enabled and DBE mode/session is also active, then both the DBE enabled and DBE activated bits are set to 1. If AP ends up disabling the DBE feature, then it would set DBE enabled bit to 0. In one embodiment, where DBE feature is not enabled or disabled dynamically, then the DBE Enabled field may not be included in the UHR Operation element.

In one embodiment, the DBE announcement and DBE parameters (after DBE BW expansion) are carried in Beacon, Probe Response, (Re)Association Response and any other management frame that is defined to carry Beacon/Probe Response level of information.

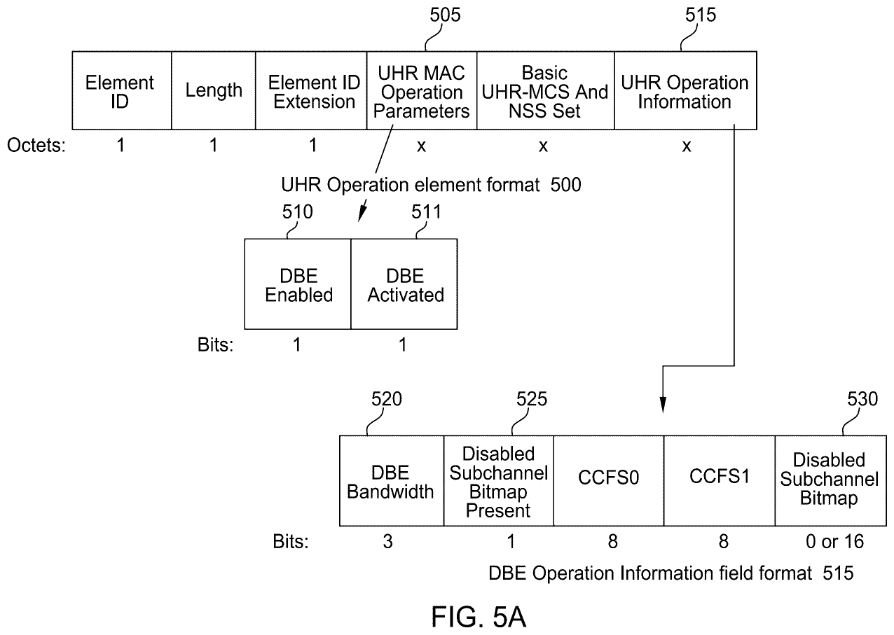

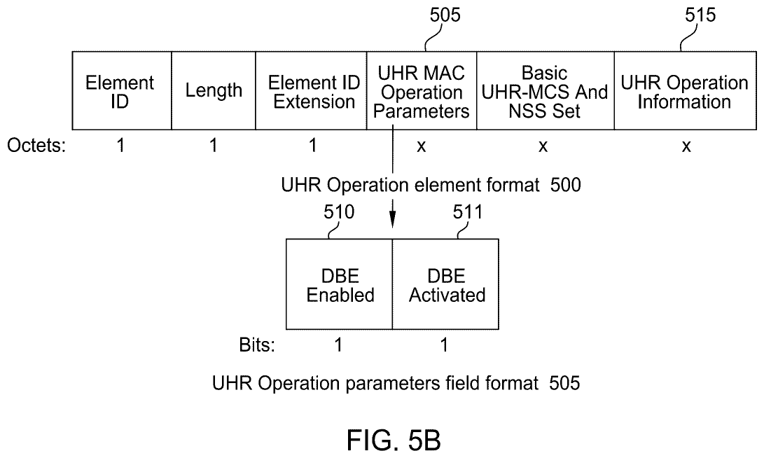

FIG. 5A is an example scheme/format for signaling DBE BW parameters, according to one embodiment. FIG. 5A illustrates a UHR operation element format 500 that can be used to signal the DBE BW parameters when the DBE is active. The format 500 includes UHR operation parameters field format 505, which in turn includes a DBE Enabled field 510 (e.g., when DBE feature can be enabled/disabled dynamically) that indicates whether the DBE feature is enabled at the AP and a DBE activated field 511 that indicates whether the AP currently has an active DBE mode/session, among other information.

The format 500 also includes UHR operation information 515, which includes such information as the DBE bandwidth 520 (e.g., which was set by the DBE announcement), the disabled subchannel bitmap flag 525 (indicating the presence of a disabled subchannel bitmap 530), and center frequency information for DBE bandwidth (e.g., represented by CCFS0 and CCFS1 fields).

FIG. 5B shows an example format for indicating an active DBE mode in the UHR operation element when DBE bandwidth parameters are not provided in the UHR Operation element format 500. Like in FIG. 5A, the DBE enabled field 510 and the DBE activated field 511 are in the UHR operation parameters field format 505. However, in this scheme, the DBE BW parameters are signaled outside of the UHR Operation element, e.g., in another UHR element defined for DBE or a common UHR element that is defined to carry parameters for multiple UHR operating modes, including DBE.

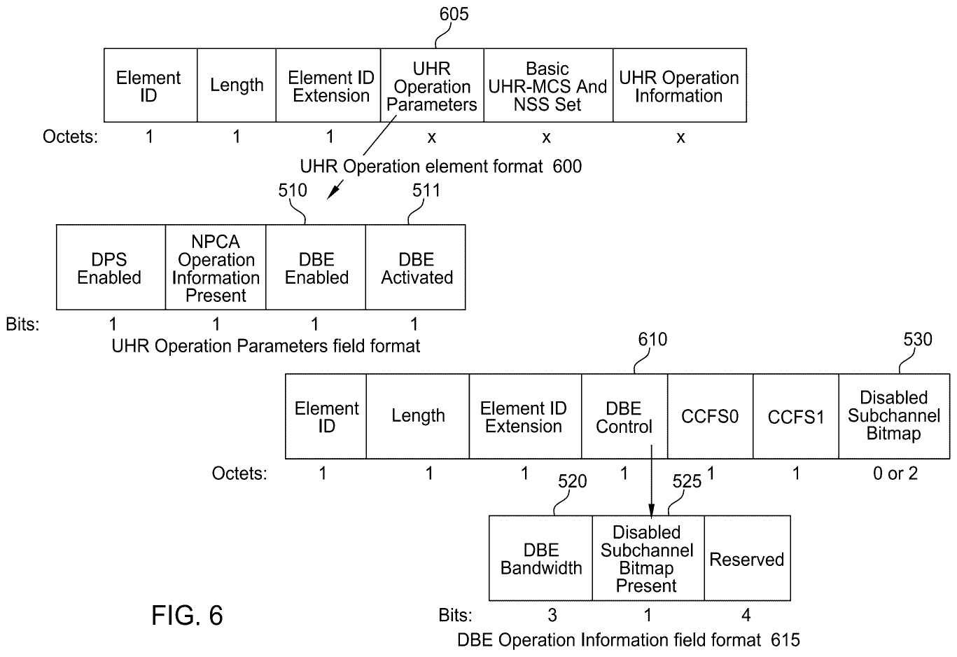

FIG. 6 is an example scheme/format for signaling DBE BW parameters, according to one embodiment. FIG. 6 illustrates alternative signaling relative to FIG. 5 of a UHR operation element format 600 that can be used to signal the DBE operation parameters 605 when the DBE is active. The signaling scheme in FIG. 6 may be preferred to minimize the amount of information in the UHR operation element. In this embodiment, the UHR operational parameters 605 is used to signal whether the DBE is active using the DBE activated field 511. Moreover, the UHR Operation element can also signal whether DBE feature is enabled in the BSS using DBE Enabled field 510 (e.g. when DBE feature can be enabled/disabled dynamically in the BSS).

A separate DBE operation information (DOI) element 615 can be used to indicate the DBE BW parameters such as a DBE control information 610 that in turn includes the DBE bandwidth 520 and the disabled subchannel bitmap present flag 525. The DOI element 615 can then include the disabled subchannel bitmap 530 and includes center frequency information for DBE bandwidth (e.g., represented by CCFS0 and CCFS1 fields).

In one embodiment, a STA that was asleep can receive the UHR operation element and determine from the DBE activated field 511 that the DBE is active. In there is no DBE bandwidth parameters being advertised in the beacon, then STA can transmit a probe request to the AP and receive a probe response from the AP to receive the DOI element 615 which has the information regarding the DBE bandwidth.

Note that for the DBE related signaling proposed in FIGS. 3-6, other formats are possible for elements/fields/subfields and frames that include the same set of information content. Moreover, the size of the fields/subfields can be different in terms of bits/octets.

In one embodiment, an AP can update its currently active DBE BW by sending out another DBE announcement in a Beacon, Probe Response, etc. that announces a changed DBE BW. The new (or changed) DBE BW can be higher or lower. For example, the AP may change the DBE BW from 160 MHz to 320 MHz or from 320 MHz to 160 MHz. The DBE announcement can include the BW Switch Count field indicating the number of TBTTs before the BW switch happens and provide the parameters for updated DBE BW as indicated above (DBE BW, center frequency for DBE BW and any disabled subchannel bitmap for DBE BW). Thus, the BW of the DBE mode can change during the active DBE mode.

In one embodiment, if the AP has already sent out a DBE announcement for changing the BW (but has not yet changed the BW) and decides to change the BW again, the AP may not send another announcement before the already announced DBE BW is active. For example, if the AP sends a DBE announcement to change from 160 MHz to 320 MHz but the time at which the BW expands has not yet been reached and the AP instead decides (or is instructed by RRM) to change to 80 MHz, the AP may wait until the BW change to 320 MHz has occurred before sending another announcement for BW the change to 80 MHz.

Alternatively, changing the current DBE BW announcement can be supported if, for example, the AP wants to make a last-minute change (e.g. due to incumbent operation observed etc.). In this case, the AP can change parameters of ongoing DBE announcement (e.g., the DBE BW and related parameters).

In one embodiment, the AP can cancel a DBE announcement for last minute changes.

Returning to the method 200, at block 225 the AP terminates the active DBE mode/session. In one embodiment, the AP terminates DBE mode/session by sending another announcement (e.g., a termination or reset announcement) that indicates the time when the DBE will end. The AP can indicate this switch time as TSF time (e.g. in units of time units (TUs)) or as number of TBTTs to signal when the DBE BW will return to the BSS operating BW. The announcement for termination of DBE bandwidth can be done using a similar DBE announcement scheme as for activation of DBE BW, with the DBE bandwidth related parameters set based on the BSS operating BW. This implies that in this DBE termination announcement, the DBE bandwidth, center frequency and any disabled subchannel parameters will be set based on BSS operating bandwidth. In this way, this specific DBE announcement indicates that the DBE BW is being reset to the BSS operating BW at the switch time indicated in the announcement and the AP will no longer be operating with expanded DBE BW after that time. The DBE supporting STAs then go back to operating using the BSS operating BW.

However, as mentioned above, in some embodiments, the DBE announcement may have indicated a duration of the DBE or an end time. In that case, the AP and STAs can return to the BSS operating BW without further signaling (e.g., without the AP transmitting a termination announcement). In one embodiment, the AP may extend the DBE duration previously indicated by sending another DBEA element in the beacon frames (and Probe Response and (Re)Association Response frames). In this case, the DBE terminates at the end of the extended DBE duration.

In one embodiment, all DBE announcements related to activation of DBE mode or any changes to DBE bandwidth for active DBE mode or termination of DBE mode are considered critical updates in the BSS, and such updates get reflected in BSS Parameters Change Count (BPCC) and Critical Update Flag (CUF) or other critical update fields defined for UHR related critical updates. For example, in one embodiment, DBE announcement increments the BPCC used for UHR critical updates and appropriately sets the CUF field used to signal UHR critical updates.

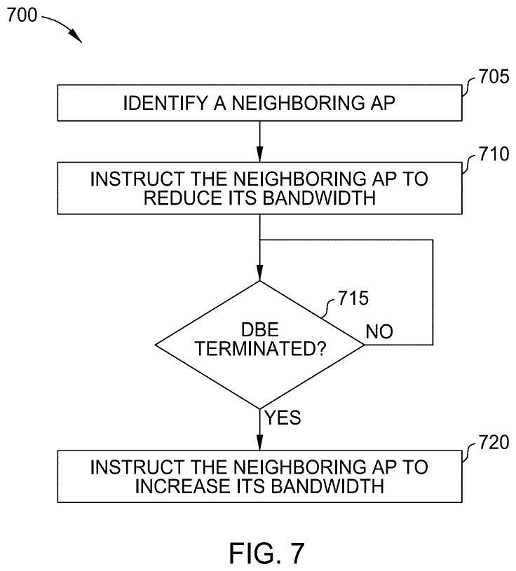

FIG. 7 is a flowchart of a method 700 for adjusting the BW of a neighboring AP in response to a DBE BW expansion, according to one embodiment. At block 705, RRM (or a network controller) identifies an AP that is a neighboring co-channel of another AP that is performing DBE. For example, the two APs may be part of the same enterprise deployment (e.g., in a same office building or campus). The AP performing DBE may currently have a higher load than the neighboring AP. For example, the AP performing DBE may be located in a conference room where a meeting is currently taking place and serving load from larger number of devices.

At block 710, RRM instructs the neighboring AP to reduce its bandwidth. Doing so may reduce the overlap between the two APs. For example, when the BW of an AP is expanded dynamically from, e.g., 80 MHz to 120 MHz, the neighboring AP should operate with a reduced BW (e.g., from 80 MHz to 40 MHz) assuming the AP performing DBE has a higher load during the duration of the DBE.

In one embodiment, the neighboring AP signals a BW reduction to its DBE supporting STAs using the same signaling approach as used for dynamic BW expansion (e.g. DBE announcement in Beacons or 1:1 indication using DBE Request/Response exchange). Instead of announcing a BW increase, the neighboring AP can indicate a BW reduction.

In one embodiment, this reduction in BW affects only the DBE supporting STAs. The neighboring AP keeps its BSS operating BW the same as before (80 MHz) so as to not impact legacy devices. Thus, the legacy devices can operate as normal and DBE supporting STAs can adapt to operating with reduced BW as indicated by DBE announcement

At block 715, the RRM or network controller determines whether the AP that was performing DBE BW expansion has terminated its DBE. For example, the load may have reduced on the AP, and the RRM can instruct that AP to terminate the DBE. Or the DBE may have had a fixed duration, in which case the RRM knows when DBE will terminate.

Once the DBE is terminated, at block 720 the RRM instructs the neighboring AP to increase its BW. In response, the neighboring AP can use the signaling above to signal its DBE supporting STAs that the BW is being returned to the BSS operating BW.

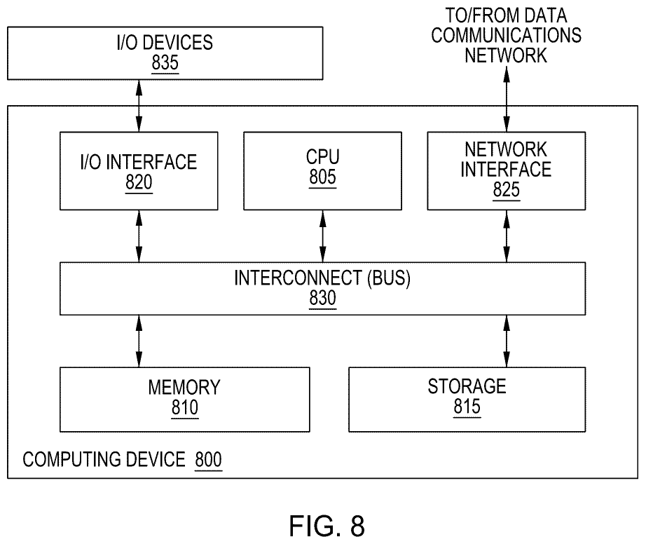

FIG. 8 depicts an example computing device configured to perform various aspects of the present disclosure, according to one embodiment. Although depicted as a physical device, in embodiments, the computing device 800 may be implemented using virtual device(s), and/or across a number of devices (e.g., in a cloud environment). In one embodiment, the computing device 800 corresponds to a network device (e.g., a computing system), such as the APs or the STAs (e.g., user devices) mentioned above.

As illustrated, the computing device 800 includes a CPU 805 (one or more processors), memory 810 (or memories), storage 815, a network interface 825, and one or more input/output (I/O) interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

The memory 810 can include software programs or application for RT-DBE as discussed above in FIGS. 1-7. Although shown as residing in memory 810, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising
managing, by an access point, a basic service set (BSS) on a first operating channel and at a first channel bandwidth;
determining a mode switch time for a Dynamic Bandwidth Expansion (DBE) mode of operation for the BSS;
prior to the mode switch time, transmitting by the access point, a wireless management frame that announces a switch to the DBE mode of operation for the BSS, the management frame including data indicating the mode switch time and one or more DBE parameters;
at the mode switch time, expanding, by the access point, a channel bandwidth of the BSS to a second channel bandwidth greater than the first channel bandwidth; and
implementing, by the access point, the BSS in the DBE mode of operation at up to the second channel bandwidth for all DBE supporting stations.

2. The method of claim 1 wherein the one or more DBE parameters comprises at least one of a center channel frequency and an expanded DBE channel bandwidth.

3. The method of claim 1 wherein the one or more DBE parameters comprises one or more punctured subchannels.

4. The method of claim 1 wherein the data indicating the mode switch time is a number of target beacon transmission times until the mode switch time.

5. The method of claim 1 further comprising
transmitting, after the mode switch time, one or more additional management frames including data indicating the DBE mode of operation as active and the one or more DBE parameters.

6. The method of claim 1 further comprising:
advertising within the BSS, by the access point, support for the DBE mode of operation.

7. The method of claim 1 wherein the wireless management frame is a beacon frame, a probe response frame or a (re)association response frame.

8. The method of claim 1 wherein the wireless management frame comprises a critical update flag set to a value indicating a critical update.

9. The method of claim 8 further comprising:
incrementing a BSS Parameters Change Count, wherein the management frame further comprises the incremented BSS parameters change count.

10. An access point comprising:
one or more memories; and
one or more processors communicatively coupled to the one or more memories, wherein the one or more processors are configured to, individually or collectively, perform operations comprising:
managing, by the access point, a basic service set (BSS) on a first operating channel and at a first channel bandwidth;
accessing a determination of a mode switch time for a Dynamic Bandwidth Expansion (DBE) mode of operation for the BSS;
prior to the mode switch time, transmitting by the access point, a wireless management frame that announces a switch to the DBE mode of operation for the BSS, the management frame including data indicating the mode switch time and one or more DBE parameters;
at the mode switch time, expanding, by the access point, a channel bandwidth of the BSS to a second channel bandwidth greater than the first channel bandwidth; and
implementing, by the access point, the BSS in the DBE mode of operation at up to the second channel bandwidth for all DBE supporting stations.

11. The access point of claim 10 wherein the one or more DBE parameters comprises at least one of a center channel frequency and an expanded DBE channel bandwidth.

12. The access point of claim 10 wherein the one or more DBE parameters comprises one or more punctured subchannels.

13. The access point of claim 10, wherein the data indicating the mode switch time is a number of target beacon transmission times until the mode switch time.

14. The access point of claim 10, the operations further comprising:
transmitting, after the mode switch time, one or more additional management frames including data indicating the DBE mode of operation as active and the one or more DBE parameters.

15. The access point of claim 10, the operations further comprising:
advertising within the BSS, by the access point, support for the DBE mode of operation.

16. The access point of claim 10 wherein the wireless management frame is a beacon frame, a probe response frame or a (re)association response frame.

17. The access point of claim 10 wherein the wireless management frame comprises a critical update flag set to a value indicating a critical update.

18. The access point of claim 17, the operations further comprising:
incrementing a BSS Parameters Change Count, wherein the management frame further comprises the incremented BSS parameters change count.

19. A non-transitory computer readable storage medium comprising instructions that when executed configure one or more processors of an access point (AP) to perform operations comprising:
managing, by the access point, a basic service set (BSS) on a first operating channel and at a first channel bandwidth;
accessing a determination of a mode switch time for a Dynamic Bandwidth Expansion (DBE) mode of operation for the BSS;
prior to the mode switch time, transmitting by the access point, a wireless management frame that announces a switch to the DBE mode of operation for the BSS, the management frame including data indicating the mode switch time and one or more DBE parameters;
at the mode switch time, expanding, by the access point, a channel bandwidth of the BSS to a second channel bandwidth greater than the first channel bandwidth; and
implementing, by the access point, the BSS in the DBE mode of operation at up to the second channel bandwidth for all DBE supporting stations.

20. The non-transitory computer readable storage medium of claim 19 wherein the one or more DBE parameters comprises at least one of a center channel frequency, an expanded DBE channel bandwidth or one or more punctured subchannels.
